(19) United States
(12) Patent Application Publication
(10) Pub. No.: US 2013/0101674 A1
(43) Pub. Date: Apr. 25, 2013

(54) BIOCIDAL COATING COMPOSITION

(71) Applicant: John Toft, Stockport (GB)

(72) Inventor: John Toft, Stockport (GB)

(73) Assignee: GX LABS HOLDINGS LIMITED, London (GB)

(21) Appl. No.: 13/699,884

(22) PCT Filed: May 20, 2011
(86) PCT No.: PCT/GB2011/050957

§ 371 Date: Nov. 26, 2012

(30) Foreign Application Priority Data
May 27, 2010 (GB) 100891.6

(51) Int. Cl. A01N 25/08; B01D 46/00; A01N 25/28; A01N 31/02; A01N 55/02

(52) U.S. Cl. CPC A01N 25/08; A01N 31/02; A01N 55/02; A01N 25/28; B01D 46/0028
USPC 424/497; 514/772; 514/705; 514/188; 96/227

(57) ABSTRACT

The present invention relates to a biocidal coating composition comprising a biocide and an organofunctional silane oligomer which is distinct from the biocide. Such compositions are suitable for application to a substrate surface to provide long term disinfection on the surface of the substrate. The organofunctional silane oligomer prolongs the action of the biocide on the surface of the substrate, and provides improved surface-retention of the biocide.

This invention relates to biocidal coating composition that is suitable for application to a substrate surface. This invention also relates to a substrate coated with the biocidal coating composition and the use of the composition for providing long term disinfection on the surface of a substrate.

### BACKGROUND

Many biocidal materials have been incorporated into compositions for coating various hard surfaces for the purpose of killing pathogens which come into contact with them and which could otherwise spread and cause infections.

In 1969 Dow Corning launched a product called ‘Aegis’ (now marketed by the Aegis Corporation), which possessed biocidal properties. This product was a silane quaternary ammonium compound, which, when applied to a surface imparted fungicidal, and some bactericidal properties. Aegis was primarily used in the textile industry, to prevent malodour in socks and stockings, work wear, upholstery and in hospital screens to control pathogens.

One problem with this silane quaternary compound was its lack potency against pathogens, particularly when tested under standard efficacy test conditions. Furthermore, the adherence of the compounds to the textile articles concerned was not sufficiently durable.

There have since been numerous approaches to attempt to improve the silane quaternary ammonium compounds by incorporating other biocides into the structure, but none of these approaches have adequately addressed the problem of long term efficacy.

Alternative approaches to address this problem have involved the use of compositions comprising one or more biocides and a polymer, such as a polysiloxane. The disadvantage of these compositions is that the biocide is only held within the physical constraints of a polymer film. Furthermore, these polymer films can suffer from poor durability as it can be removed from the treated surface by abrasion or washing.

These different approaches have not addressed the fundamental problem of how to achieve the maximum residual effect of prolonged biocidal efficacy on all surfaces.

Hospitals, nursing homes, clinics, and cruise ships, commercial and industrial premises are all seeing a rise in outbreaks of illnesses caused by pathogens such as Novovirus, Rotavirus, Coronavirus, influenza and spores such as those of Clostridium difficile.

An object of the present invention is to provide a biocidal coating composition suitable for a variety of purposes.

It is a further object of the present invention to provide a biocidal composition that has potent biocidal properties and which can also demonstrate good adherence to a substrate surface.

It is a further object of the present invention to provide a durable coating of the biocidal composition on the surface of a substrate which also does not substantially affect the inherent properties of the surface to which it has been applied.

### BRIEF SUMMARY OF THE DISCLOSURE

In order to address the drawbacks associated with the prior art compositions, it is necessary to provide a biocidal composition which retains the biocide on the surface of a substrate by providing a composition that is chemically and/or physically bonded to the surface of the substrate, without affecting the inherent properties of that surface.

On the basis of investigations carried out by the applicants, it has been concluded that the most effective substances for providing a robust and long-lasting surface coating of a biocide are organofunctional silane oligomers, applied from either aqueous or solvent media.

Organofunctional silane oligomers (e.g. dimers, trimers, tetramers, pentamers etc.) are sufficiently small to penetrate deep into a surface, which can lead to covalent bonding with the surface, as well as self polymerising in situ. Another advantage of these oligomers is that different organofunctional groups can be present within the same silane oligomer molecule; this therefore gives extra versatility to enable the oligomeric silane to be customised for the desired application. For example, these functional groups can be selected or “engineered” to conform to the desired conditions of cure, for example ambient temperature, elevated temperature or UV cure.

Following application to the surface of a substrate, the compositions of the present invention form a durable micro or nanofilm of biocide on the coated surface.

The applicant has found that silane oligomers with many functional amino groups do possess some antimicrobial activity (mainly fungicidal) in their own right.

Thus, in a first aspect, the present invention provides a biocidal composition comprising a biocide and an organofunctional silane oligomer.

The improvements in biocidal performance (effective life and kill rate) that are achieved with compositions in accordance with the invention are believed to be due to the mixing of the essential components of the composition, namely the oligomeric silane and the particular biocide or biocides chosen to give optimum performance for the application concerned. The effect is further enhanced by the addition of a film-forming agent to the composition prior to the application of the composition as a coating. The film-forming agent holds the other compounds onto the substrate surface to which they are applied for much longer and in a higher concentration than is otherwise possible.

In a further aspect, the present invention provides a substrate having a surface coated with a biocidal composition as defined herein.

In yet another aspect, the present invention provides a method of providing long term disinfection to the surface of a substrate, the method comprising applying a biocidal composition as defined herein to the surface.

### BRIEF DESCRIPTION OF THE DRAWINGS

Particular embodiments of the invention are further described hereinafter with reference to the accompanying drawings, in which:

FIG. 1 is a diagram showing polyhedral cage structures of a silsesquioxane; and

FIG. 2 is a diagram showing a ladder structure of a silsesquioxane.

### DETAILED DESCRIPTION OF THE INVENTION

### Biocidal Compositions

As stated above, the present invention provides a biocidal composition comprising a biocide and an organofunctional silane oligomer.

Any suitable biocide may be used in the compositions of the present invention. The biocide is suitably a broad spectrum biocide that has activity against a broad spectrum of pathogens, including bacteria, fungi and viruses.

Examples of suitable biocides include, but are not limited to, quaternary ammonium compounds (from Lonza), biguanides (Arch Chemicals), guanidines (Lonza), glutaraldehyde (Dow, BASF), formaldehyde (Tennants), iodophors (ISP), chlorines (Ineos), phenol derivatives (Quatchem), amines (Akzo), metal salts (Arch Chemicals) Bronopol (BASF) oxidising agents (DuPont), acids (Univar), alkalis (Tennants), etc., and are present in the soluble or insoluble form. The above manufacturers quoted are by way of example. These materials are well known in the art and have been used in formulations of biocidal compositions.

The preferred biocides are glutaraldehyde, quaternary ammonium compounds, biguanides and metal salts.

The amount of biocide present in the composition of the invention may vary. Suitably, the biocide is present in an amount ranging from 0.05% to 10% w/v of the total composition. One or more biocides may be present in the same composition.

In an embodiment of the invention, the biocide is dispersed throughout the composition of the invention, but it is not chemically bonded to the organofunctional silane oligomer. Suitably, the biocide is physically encapsulated within the organofunctional silane oligomer network.

In a particular embodiment, the biocide is microencapsulated in a polymer matrix prior to its addition to an organofunctional silane oligomer, which will give a composition with slow or controlled release capability, as well as better longevity (i.e. better residual biocide efficacy). Such embodiments may also be more acceptable from a regulatory perspective.

The term “organofunctional silane oligomer” is used herein to refer to silane oligomers that comprise an organofunctional substituent group. Any suitable silane oligomer may be used in the compositions of the present invention.

The amount of “organofunctional silane oligomer” present in the composition of the invention may vary. Suitably, the amount of silane oligomer present is within range of 0.05% to 15% w/v of the total composition. One or more silane oligomers may be present in the same composition.

In an embodiment of the invention, the organofunctional silane oligomer is selected from a silane oligomer, as defined herein, a silsesquioxane, a dipodal silane or mixtures thereof.

In an embodiment, the silane oligomer comprises 2 to 15 monomer units.

In a further embodiment, the silane oligomer comprises 2 to 10 monomer units.

In an embodiment, the silane oligomer is formed by the condensation of a silane monomer of the formula:

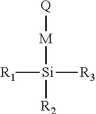

wherein:

Q is a functional group (e.g. halo, hydroxyl, nitro, cyano, carboxy, amino);

M is absent or a linker (e.g. 1-10C alkylene);

at least one of R₁, R₂ and R₃ is hydroxyl and the others are selected from halo, hydroxyl, (1-10C)alkyl, (2-10C)alkenyl and (2-10C)alkynyl, or (1-10C)alkoxy.

Suitably, R₁, R₂ and R₃ are all hydroxyl.

Q may be any suitable functional group known in the art. In the silane oligomers formed by the condensation of these monomers, each Q group may be the same or different.

For example, each Q group may be independently selected from halo, hydroxyl, nitro, cyano, carboxy, amino, vinyl, acrylate, methacrylate, an epoxide ring, or a group defined by the formula:

L₀-Q₁

wherein L₀ is selected from —O—, —C(O)—, —OC(O)—, —C(O)O—, —O(CH₂)ₘ where m is an integer between 1 and 3; and
wherein Q₁ is selected from (1-8C)alkyl, (2-8C)alkenyl (e.g. vinyl), (2-8C)alkynyl, or an epoxide ring and wherein any (1-8C)alkyl, (2-8C)alkenyl, (2-8C)alkynyl Q₁ group is optionally substituted by one or more substituents selected from halo, hydroxyl, nitro, cyano, carboxy, amino, vinyl, acrylate, methacrylate, and an epoxide ring.

In an embodiment, Q is a group defined by the formula:

L₀-Q₁

wherein L₀ is selected from —OC(O)— or —O(CH₂)ₘ where m is 1; and
wherein Q₁ is selected from vinyl or an epoxide ring.

In a particular embodiment, where glutaraldehyde is present as a biocide, the organofunctional silane oligomer is free of amino functional groups (e.g. Q is not amino or does not comprise an amino group as a substituent).

M may be any suitable linker group known in the art. Suitably M is alkylene, especially a 1-5C alkylene, and in particular 2-4C alkylene.

In an embodiment, the silane oligomer has the formula:

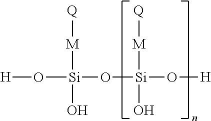

wherein M and Q are as defined above and n is 1 to 14, more preferably 1 to 9.

In a further embodiment, the organofunctional silane oligomer is silsesquioxane. Silsesquioxanes are known in the art and possess the empirical formula RSiO_{1.5}, where R is an organofunctional group, such as a group Q or -M-Q defined above. Preferably at least one R group of the silsesquioxane is a group -M-Q as defined herein. As before, each R group present may be the same or different. Water soluble silsesquioxanes are rich in hydroxyl R groups. In a particular embodiment, some R groups are groups M-Q as defined herein, whilst others are selected from hydroxyl, 1-10C alkyl, or 1-10C fluoroalkyl. In such cases, suitably under half of the R groups are defined by M-Q.

Silsesquioxanes provide a flexible ceramic backbone with differing organofunctional side groups. New generation hybrid oligomeric silsesquioxanes give better hydrolytic stability, outstanding abrasion performance and yield three dimensional polymer networks. The properties of the final polymer are determined by the molecular make up and reactivity of functional side groups.

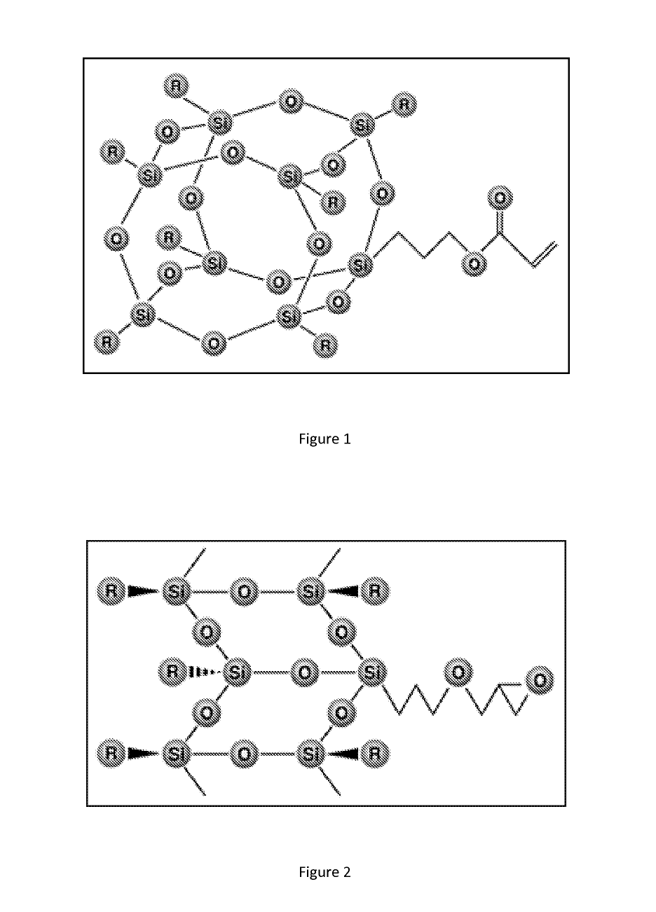

Silsesquioxanes can provide a range of three dimensional forms, including a polyhedral cage structures (see FIG. 1) and ladder structures (see FIG. 2).

In a further embodiment, the organofunctional silane is a dipodal silane. Dipodal silanes are known in the art and can improve the bonding and stability of the composition. In addition, by adding these dipodal silane there is further enhancement of the hydrolytic stability of the system. The main advantage of these dipodal silanes is their ability to form six bonds with the substrate as opposed to three.

A typical structure if dipodal silane is shown below

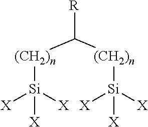

The R group is a non-hydrolysable organic radical. Any suitable organic radical may be used. Suitably, the organic radical is capable of bonding with organic resins and polymers.

The X group is hydrolysable (typically alkoxy, acyloxy or chlorine) and enables the silicon group to bond with inorganic substrates.

Commercial examples of suitable silanes include Dynasylan from Evonik, Vitolane from TWI Cambridge and Dipodal Silanes from Gelest Inc.

Silanes can also react with insoluble inorganic or organic particulate matter and bind these to substrate surfaces. The oligomeric silane has the ability, depending on structure, to interpenetrate the polymer and substrate and bond in a three dimensional network.

In an embodiment, the composition further comprises additional polymeric components that influence the physical properties of the composition, for example its durability.

In a particular embodiment, the composition further comprises a film forming agent. The term “film-forming agent” as used in this document is of wide scope and is intended to encompass any substance which facilitates coating of a substrate in a manner of a thin film, including substances which may be termed binding substances and adhesives.

A suitable film-forming agents may be selected from any one of the following: polyamide, polyester, polyethylene oxide, polyurethane, polyvinylpyrrilidone, polyacrylate, polymethacrylate, polyurethane, polyvinyl alcohol, epoxy resins, polyglycols, polysiloxanes polysaccharides, and polymers referred to as ‘polyquaterniums’. These polymers, and others not mentioned here, may be present on their own, in blends, or as copolymers or derivatives.

The preferred polymers are polyvinylpyrrilidone, polyurethane and polyquaternium their copolymers and derivatives.

Examples of polyquaterniums include the following:

| | | Trade |
|---|---|---|
| Polyquaternium | Chemical Identity | Names |
| Polyquaternium-1 | Ethanol, 2,2′,2″-nitrilotris-, polymer with 1,4-dichloro-2-butene and | |
| | N,N,N′,N′-tetramethyl-2-butene-1,4-diamine | |
| Polyquaternium-2 | Poly[bis(2-chloroethyl) ether-alt-1,3-bis[3-(dimethylamino)propyl]urea] | |
| Polyquaternium-4 | Hydroxyethyl cellulose dimethyl diallylammonium chloride copolymer; | CELQUAT |
| | Diallyldimethylammonium chloride-hydroxyethyl cellulose copolymer | L-200 |
| Polyquaternium-5 | Copolymer of acrylamide and quaternized dimethylammoniumethyl | |
| | methacrylate | |
| Polyquaternium-6 | Poly(diallyldimethylammonium chloride) | |
| Polyquaternium-7 | Copolymer of acrylamide and diallyldimethylammonium chloride | |
| Polyquaternium-8 | | |
| Polyquaternium-9 | | |
| Polyquaternium- | Quaternized hydroxyethylcellulose | |
| 10 | | |
| Polyquaternium- | Copolymer of vinylpyrrolidone and quaternized dimethylaminoethyl | |
| 11 | methacrylate | |
| Polyquaternium- | | |
| 12 | | |
| Polyquaternium- | | |
| 13 | | |
| Polyquaternium- | | |
| 14 | | |
| Polyquaternium- | Acrylamide-dimethylaminoethyl methacrylate methyl chloride copolymer | |
| 15 | | |
| Polyquaternium- | Copolymer of vinylpyrrolidone and quaternized vinylimidazole | |
| 16 | | |
| Polyquaternium- | | |
| 17 | | |
| Polyquaternium- | | |
| 18 | | |
| Polyquaternium- | | |
| 19 | | |
| Polyquaternium- | | |
| 20 | | |
| Polyquaternium- | Copolymer of Acrylic Acid and Diallyldimethylammonium Chloride | |
| 22 | | |
| Polyquaternium- | | |
| 24 | | |
| Polyquaternium- | | |
| 27 | | |
| Polyquaternium- | Copolymer of vinylpyrrolidone and methacrylamidopropyl | |
| 28 | trimethylammonium | |
| Polyquaternium- | | |
| 29 | | |
| Polyquaternium- | | |
| 30 | | |
| Polyquaternium- | | |
| 31 | | |
| Polyquaternium- | Poly(acrylamide 2-methacryloxyethyltrimethyl ammonium chloride) | |
| 32 | | |
| Polyquaternium- | | |
| 33 | | |
| Polyquaternium- | | |
| 34 | | |
| Polyquaternium- | | |
| 35 | | |
| Polyquaternium- | | |
| 36 | | |
| Polyquaternium- | Poly(2-methacryloxyethyltrimethylammonium chloride) | |
| 37 | | |
| Polyquaternium- | Terpolymer of Acrylic Acid, Acrylamide and Diallyldimethylammonium | |
| 39 | Chloride | |
| Polyquaternium- | | |
| 42 | | |
| Polyquaternium- | | |
| 45 | | |
| Polyquaternium- | Terpolymer of vinylcaprolactam, vinylpyrrolidone, and quaternized | |
| 46 | vinylimidazole | |
| Polyquaternium- | Terpolymer of Acrylic Acid, Methacrylamidopropyl Trimethyl Ammonium | |
| 47 | Chloride, and Methyl Acrylate | |

The amount of film forming material present will vary. Typically, amounts within the range of 0.05% to 15% w/w or w/v of the total composition will be present. One or more polymer may be present in the same composition.

The compositions of the invention may be applied in the form of an aqueous solution or a solution in a suitable solvent. Suitable solvents for use in the composition of the invention are any one or more of ethanol, isopropanol and butanol. Other suitable solvents include chlorinated hydrocarbons such as trichlorethane.

The coating compositions in accordance with the invention may be usefully applied to many surfaces where it is required to avoid the residence of pathogens.

Examples of surfaces to which the biocidal composition can be applied are outlined in the following paragraphs.

Fibres or other surfaces of an air filter cartridge may be coated with a composition in accordance with the invention so as to kill a sufficiently high proportion of the pathogens in the air which are passed through the filter to lower the bio-burden to below that where infection is likely. The coating procedure may be simplified by use of a composition in accordance with the present invention. The filter element is simply immersed in the coating composition which is in the form of a solution. Other methods of applying the coating may be used. The material of the filter element, which may be fibrous or may be a reticulated foam or maybe some other porous material, may then be compressed to expel any air and then dried in a warm air current to evaporate the water (or solvent which may be recovered by condensation). The dried air filter element can then be assembled into a suitable frame (such as a cardboard frame) to form a filter cartridge. It can then be packed in a suitable airtight bag, such as of plastics material, until the moment of use so that its efficacy is not compromised by spurious air content whilst in storage or transit.

Walls and other structural surfaces may be coated with a composition in accordance with the invention by wiping, brushing, roller application or spraying so as to produce an effective biocidal surface for a sufficiently long period of time to be cost effective. In accordance with the invention the combination of the essential active biocides with the oligomeric silane and with the binding agent can produce a biocidal coating with a significantly longer effective life than application of a composition containing any single active biocide without the addition of the binder.

Hard surfaces may be coated with a composition in accordance with the invention by normal application procedures, so as to prevent the presence of live pathogens on those surfaces, such metal, glass, ceramics, wood, plastics etc.

Skin, particularly the hands, may be coated with a biocidal composition in accordance with the invention that not only kills any pathogens on the skins/hands at the time of application but continues over a period of time to kill any further pathogens which come into contact with the treated skin/hands.

### EXAMPLES

How the invention may be put into effect will now be described by way of example only in reference to the following Examples.

### Example 1

### Filter Media Coating

A suitable coating composition is made with a biocide, film-forming agent, organofunctional silane oligomers, deionised water and/or solvent. The resulting coating on the filter, which is suitably of fibrous material, is at a concentration of 0.5-4 wt % on the weight of the fibre and at a typically submicron film thickness. Note that these examples are for the purpose of illustration only, and other biocides and/or film formers may be used, depending on the level of biocide protection required and any regulatory limitation in that particular country.

### Composition 1

### Filter Media Coating with Stabilised Glutaraldehyde

| | |
|---|---|
| Deionised or distilled water | 40-800 g/l |
| Solvent (e.g. ethanol) | 40-800 g/l |
| Stabilised glutaraldehyde (G-Cide ®) | 5-100 g/l (expressed as |
| | from 100% glutaraldehyde) |
| Vitolane ® or Dynasylan ® silane oligomer | 5-400 g/l |
| Film forming polymer (PVP, PVA, PU etc) | 5-200 g/l |
| pH modifier (e.g. NaOH) | to pH 5.0-7.0 |
| bulk with water or alcohol | to 1000 ml |

Note the optimum pH of application in most cases is between pH 5.0-7.0.

Note the amount of solvent can vary in all formulations from 0-90% depending on the speed of drying required.

### Composition 2

### Filter Media Coating with Polymeric Biquanides

| Deionised or distilled water | 40-800 | g/l |
|---|---|---|
| Solvent (e.g. ethanol) | 40-800 | g/l |
| Polymeric biguanide (Vantocil ®) | 5-200 | g/l |
| Zinc Pyrithione | 5-200 | g/l |
| Vitolane ® or Dynasylan ® silane oligomer | 5-400 | g/l |
| Film forming polymer (PVP, PVA, PU etc.) | 5-200 | g/l |
| pH modifier (e.g. NaOH) | to pH 5.0-7.0 | |
| bulk with water or alcohol | to 1000 | ml |

Note the optimum pH of application in most cases is between pH 5.0-7.0

The amount of solvent can vary in all formulations from 0-90% depending on the speed of drying required.

A preferred embodiment of a filter assembly in accordance with one aspect of this invention comprises a first filter element consisting of fibrous material or reticulated foam onto or into which a biocidal composition according to the present invention has been coated.

In a particular embodiment, the filter assembly comprises a first filter element consisting of fibrous material or reticulated foam onto or into which a biocidal composition comprising glutaraldehyde and organofunctional silane (such as Example 1 above) has been coated, and a second filter element, mounted at a spacing downstream of the first filter element, this second filter element also consisting of fibrous material or reticulated foam, but onto or into which a biocidal composition such as a polymeric biguanide and/or other biocide, an organofunctional silane and a film-forming agent has been coated, as example 1a above.

### Example 2

### Hard Surface Treatment

| | | |
|---|---|---|
| Deionised or distilled water | 600-950 | g/l |
| Solvent (e.g. ethanol) | 00-200 | g/l |
| Polymeric Biguanide | 0.5-10 | g/l |
| Quaternary Ammonium compound | 0.5-10 | g/l |
| Bronopol ® | 0.5-10 | g/l |
| Vitolane ® or Dynasylan ® silane oligomer | 5-400 | g/l |
| Film forming polymer (PVP, PVA, PU etc.) | 5-100 | g/l (optional) |

| | |
|---|---|
| pH modifier (e.g. NaOH) | to pH 5.0-7.0 |

| | | |
|---|---|---|
| bulk with water or alcohol | to 1000 | ml |

The formulation may be applied by spray and wiping with a clean cloth or wiping the hard surface with an impregnated wipe material.

### Example 3

### Hard Surface Coating (Solvent Based)

A suitable coating compound is made with biocide suitable for the application, optional film former and oligomeric silane. It may be applied by padding (in the case of textiles) fogging, high pressure spray, brush etc., to any hard surface and will provide effective biocidal protection for varying period of time depending upon the circumstances.

| Deionised or distilled water | 0-200 | g/l |
|---|---|---|
| Solvent (e.g. ethanol) | 800-950 | g/l |
| Polymeric Biguanide | 0.5-20 | g/l |
| Zinc Pyrithione | 0.5-20 | g/l |
| Vitolane ® or Dynasylan ® silane oligomer | 0.5-400 | g/l |
| Film forming polymer (PVP, EVA or PVA etc) | 5-200 | g/l |
| pH modifier (e.g. NaOH) | to pH 5.0-7.0 | |
| bulk with water or alcohol | to 1000 | ml |

### Example 4

### Hand Coating Composition

A suitable coating compound is made with any biocide which is skin compatible in that application, along with optional film former. It may also be advantageous to add a gelling agent and/or a fragrance so as to make the compound easier and more pleasant for the user to apply.

The recipe below is for a hand sanitiser which is rubbed into the hands for skin disinfection and not washed off. Alcohol is incorporated as a disinfectant and drying agent, normally isopropanol and/or ethanol are used for this application, but complaints of dryness and skin cracking have made it unpopular with nursing staff in hospitals, and in food factories resistance has arisen in workers who cannot use alcohol based products for religious reasons. It has been surprisingly found that dioxolane, (an ether based product), performs just as well in the recipe below.

| | |
|---|---|
| Deionised or distilled water | 300-950 g/l |
| Solvent (e.g. alcohol or dioxolane) | 10-800 g/l |
| Stabilised glutaraldehyde (G-Cide) | 0.5-5 g/l (expressed as |
| | from 100% glutaraldehyde) |
| Gelling agent | 2.0-20.0 g/l |
| Vitolane ® or Dynasylan ® silane oligomer | 5.0-100 g/l |
| Conditioning agent (glycerine) | 5.0-50 g/l |
| Film forming polymer (PVP, PVA, PU etc.) | 5.0-100 g/l (optional) |
| pH modifier (e.g. NaOH) | to pH 5.0-7.0 |
| bulk with water or alcohol | to 1000 ml |

Other suitable biocides may added or substituted in the above recipe.

Suitable gelling agents in the above recipe are a cationic polyacrylate available as Ultragel 300 from a company called Cognis or a polysaccharide Xanthan gum as available from a company called CP Kelso, or Jaguar, a guar gum from Rhodia.

Note the above recipes are by way of example and may vary considerably depending on circumstances of use and pathogens which are to be eradicated.

Throughout the description and claims of this specification, the words “comprise” and “contain” and variations of them mean “including but not limited to”, and they are not intended to (and do not) exclude other moieties. Throughout the description and claims of this specification, the singular encompasses the plural unless the context otherwise requires. In particular, where the indefinite article is used, the specification is to be understood as contemplating plurality as well as singularity, unless the context requires otherwise.

Compounds, chemical moieties or groups described in conjunction with a particular example of the invention are to be understood to be applicable to any other example described herein unless incompatible therewith. All of the features disclosed in this specification and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification or to any novel one, or any novel combination, of the steps of any method or process so disclosed.

1-16. (canceled)

17. A biocidal coating composition comprising a biocide and an organofunctional silane oligomer; wherein the biocide is dispersed throughout the composition of the invention, but it is not chemically bonded to the organofunctional silane oligomer.

18. A composition according to claim 17, wherein the biocide is selected from the group consisting of quaternary ammonium compounds, biguanides, guanidines, glutaraldehyde, formaldehyde, iodophors, chlorines, phenol derivatives, amines, metal salts, and Bronopol oxidising agents.

19. A composition according to claim 17, wherein the biocide is present in an amount ranging from 0.05% to 10% w/v of the total composition.

20. A composition according to claim 17, wherein the biocide is microencapsulated in a polymer matrix prior to its addition to an organofunctional silane oligomer.

21. A composition according to claim 17, wherein the amount of silane oligomer present is within range of 0.05% to 15% w/v of the total composition.

22. A composition according to claim 17, wherein the organofunctional silane oligomer is selected from a silane oligomer, as defined herein, a silesquioxane, a dipodal silane and mixtures thereof.

23. A composition according to claim 22, wherein the silane oligomer comprises 2 to 15 monomer units.

24. A composition according to claim 22, wherein the silane oligomer is formed by the condensation of a silane monomer of the formula: 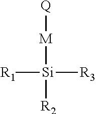
wherein:
Q is a functional group (e.g. halo, hydroxyl, nitro, cyano, carboxy, amino);
M is absent or a linker (e.g. 1-10C alkylene); and
at least one of R₁, R₂ and R₃ is hydroxyl and the others are selected from halo, hydroxyl, 1-10C alkyl, 2-10C alkenyl and 2-10C alkynyl.

25. A composition according to claim 17, wherein the organofunctional silane oligomer is silsesquioxane.

26. A composition according to claim 17, wherein the organofunctional silane is a dipodal silane.

27. A composition according to claim 17, wherein the composition further comprises additional polymeric components.

28. A composition according to claim 27, wherein the composition further comprises a film forming agent.

29. A composition according to claim 17, wherein the composition is applied in the form of an aqueous solution or a solution in a suitable solvent.

30. A substrate having a surface coated with a biocidal composition according to claim 17.

31. A method of disinfecting the surface of a substrate, the method comprising applying a biocidal composition according to claim 17 to the surface.

32. A biocidal filter element comprising fibrous material or reticulated foam onto or into which a composition as defined in claim 17 has been coated.
